(19) United States
(12) Patent Application Publication
(10) Pub. No.: US 2014/0226547 A1
(43) Pub. Date: Aug. 14, 2014

(54) SELECTION OF A TRANSMISSION MODE FOR WIRELESS COMMUNICATIONS WITH A MOBILE DEVICE

(71) Applicant: TELEFONAKTIEBOLAGET L M ERICSSON (PUBL), Stockholm (SE)

(72) Inventor: Ahmed Zainaldin, Ottawa (CA)

(73) Assignee: Telefonaktiebolaget L M Ericsson (Publ), Stockholm (SE)

(21) Appl. No.: 13/764,242

(22) Filed: Feb. 11, 2013

(51) Int. Cl. H04W 72/04

(52) U.S. Cl. CPC H04W 72/0473
USPC 370/311; 370/329; 370/315

(57) ABSTRACT

Mechanisms for selecting a transmission mode for wireless communications with a mobile device are disclosed. A controller node determines a plurality of rate regions. Each rate region corresponds to a transmission mode of a plurality of transmission modes. A selected rate region of the plurality of rate regions is identified. The controller node engages in wireless communications with the mobile device using a selected transmission mode that corresponds to the selected rate region.

### TECHNICAL FIELD

The embodiments relate generally to wireless communications, and in particular to the selection of a transmission mode of a plurality of transmission modes for wireless communications with a mobile device.

### BACKGROUND

Wireless communication channels between a controller node and a mobile device often suffer from one or more channel degradations, or channel impairments, such as noise, interference, fading, or the like, which reduces overall system throughput. Any number of factors may degrade a wireless channel. Such factors may include the distance between the controller node and the mobile device, objects, both man-made and natural, that may be between the controller node and the mobile device, and other electronic devices that may generate energy at or about the frequencies used by the controller node and mobile device to communicate data. Degraded wireless channels result in data retransmissions which can dramatically reduce system throughput.

As a mobile device nears a cell edge, the distance between the mobile device and the controller node may be a primary cause of a degraded wireless channel. Increasingly, relay nodes are being incorporated into the design of wireless communications systems, such that communications between a controller node and mobile device are relayed from one to the other by an intermediate relay node. Due to the proximity of the relay node to the mobile device and to the controller node, the quality of the wireless channels between the controller node and the relay node, and between the relay node and the mobile device, may be much better than the quality of the wireless channel that would otherwise exist between the controller node and the mobile device, thereby reducing retransmissions of data. As disclosed in U.S. Patent Publication No. 2012/0250545, relay nodes may also facilitate diversity since a receiving network node may receive multiple copies of a transmitted packet of data. Unfortunately, relaying packets requires more time slots to communicate data than direct communications between the controller node and the mobile device, and thus, the use of relay nodes may also tend to reduce system throughput. In at least some circumstances where relay nodes are used in a wireless communications system, the wireless channel between the controller node and the mobile device may be of a sufficient quality such that it would be preferable, from a system throughput perspective, to communicate directly between the controller node and the mobile device rather than through the relay node.

As disclosed in U.S. Patent Publication No. 2012/0155373, data multiplexing techniques, such as network coding, may at times be beneficial in increasing system throughput, especially when a relay node is involved in communications. However, in telecommunications systems such as Long Term Evolution (LTE), which use different modulation schemes for the uplink and the downlink, network coding may not be feasible. Moreover, the use of network coding requires that the network-coded packets be transmitted at the higher power of the uplink power and the downlink power to ensure that both the controller node and the mobile device receive the data. In some situations, the use of the higher power during a particular time slot may result in an overall lower system throughput than would occur if the lower power had been used during the particular time slot, as may have occurred if network coding were not being used.

### SUMMARY

The embodiments relate to the selection of a transmission mode for wireless communications with a mobile device. In one embodiment, a controller node determines a plurality of rate regions between the controller node and the mobile device. Each rate region corresponds to a transmission mode of a plurality of transmission modes. A selected rate region is identified. The controller node engages in wireless communications with the mobile device using a selected transmission mode that corresponds to the selected rate region. The present embodiments, among other advantages, increase system throughput of a wireless communications system.

In one embodiment, a first rate region is determined based on a first rate region formula associated with a direct transmission mode of the plurality of transmission modes. A second rate region is determined based on a second rate region formula associated with a relay transmission mode of the plurality of transmission modes. A third rate region is determined based on a third rate region formula associated with a network coding transmission mode of the plurality of transmission modes. The selected rate region is the one of the first rate region, the second rate region, and the third rate region that results in the greatest throughput between the controller node and the mobile device.

In one embodiment, the telecommunications system is a Long Term Evolution Advanced (LTE-A) wireless communications system. An Evolved Universal Terrestrial Radio Access Network Node B (eNodeB) determines a plurality of rate regions. Each rate region corresponds to a transmission mode of a plurality of transmission modes. The eNodeB identifies a selected rate region of the plurality of rate regions, and engages in wireless communications with the UE device using a selected transmission mode that corresponds to the selected rate region.

In one embodiment, the eNodeB sends a control signal to a relay node in a downlink control channel that identifies the selected transmission mode. The downlink control channel may comprise, for example, a relay physical downlink control channel (R-PDCCH), or a relay physical downlink shared channel (R-PDSCH).

In another embodiment, the relay node implements the selected transmission mode between the controller node and the mobile device. The relay node receives, from the controller node, the control signal identifying the selected transmission mode. The relay node then relays information from the controller node to the mobile device in accordance with the selected transmission mode. The relay node may also relay information from the mobile device to the controller node in accordance with the selected transmission mode.

In one embodiment, the relay node receives a first packet of data from the controller node that is destined for the mobile device. The relay node receives a second packet of data from the mobile device destined for the controller node. The relay node network codes the first packet and the second packet to generate a network-coded packet, and broadcasts the network coded packet to the controller node and the mobile device using orthogonal frequency-division multiple access (OFDMA).

The relay node may use an uplink transmit power level for wireless transmissions to the controller node and a downlink transmit power level for wireless transmissions to the mobile device. The relay node may broadcast the network-coded packet to the controller node and the mobile device using the higher transmit power level of the uplink transmit power level and the downlink transmit power level.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A-1C are block diagrams illustrating different transmission modes that may be used for wireless communications between a controller node and a mobile device according to some embodiments;

FIG. 2 is a flowchart illustrating a method for selecting a transmission mode for wireless communications with a mobile device according to one embodiment;

FIG. 3 is a block diagram illustrating a radio frame showing example wireless communications between the controller node and the mobile device in accordance with a direct transmission mode according to one embodiment;

FIG. 4 is a block diagram illustrating a radio frame showing example wireless communications between the controller node and the mobile device via a relay node in accordance with a relay node transmission mode according to one embodiment;

FIG. 5 is a block diagram illustrating a radio frame showing example wireless communications between the controller node and the mobile device via a relay node in accordance with a network coding transmission mode according to one embodiment;

FIG. 6 is a block diagram of a controller node suitable for implementing aspects of the embodiments disclosed herein;

FIG. 7 is a block diagram of a relay node suitable for implementing aspects of the embodiments disclosed herein; and

FIG. 8 is a block diagram of a mobile device suitable for implementing aspects of the embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The embodiments relate to the selection of a particular transmission mode for wireless communications between a controller node and a mobile device. In particular, a controller node may determine a plurality of rate regions, wherein each rate region corresponds to a particular transmission mode of a plurality of different transmission modes. The controller node may identify a selected rate region of the plurality of rate regions, and then engage in wireless communications with the mobile device using a selected transmission mode that corresponds to the selected rate region. The present embodiments help ensure system throughput is maximized by selecting a preferable transmission mode for wireless communications in lieu of merely using a default transmission mode.

References herein to communications between the controller node and the mobile device encompass direct wireless communications between the controller node and the mobile device as well as indirect communications that are facilitated via one or more relay nodes.

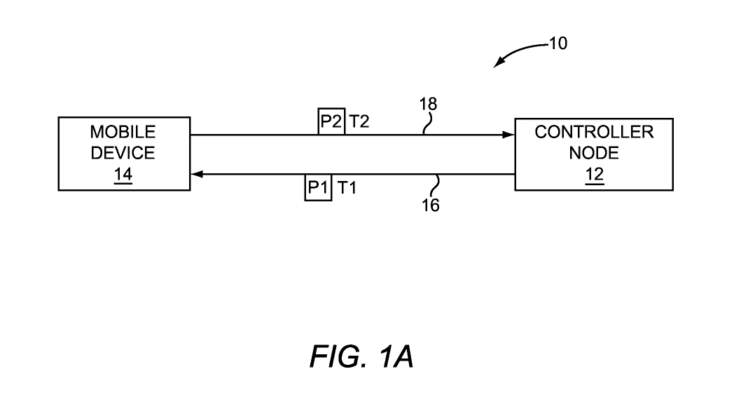

Before delving into the details of the embodiments, reference will be made to FIGS. 1A-1C, which are block diagrams illustrating different transmission modes that may be used for wireless communications between a controller node and a mobile device according to some embodiments. FIG. 1A is a block diagram illustrating a direct transmission mode according to one embodiment. A system 10 includes a controller node 12 and a mobile device 14. The controller node 12 may comprise any computing or processing device capable of facilitating communications with one or more mobile devices 14. In one embodiment, the controller node 12 may comprise a base station in a cellular wireless communications system, such as for example, an Evolved Universal Terrestrial Radio Access Network Node B (eNodeB) in a 4G 3^{rd} Generation Partnership Project (3GPP) Long Term Evolution (LTE), or LTE-Advanced (LTE-A), cellular communications system. Alternatively, in a local area network (LAN) wireless communications system, the controller node 12 may comprise, for example, a wireless access point (WAP). The mobile device 14 may comprise, for example, any computing or processing device capable of wirelessly communicating with the controller node 12. In the context of a LTE or LTE-A wireless communications system, the mobile device 14 may comprise a user equipment (UE).

Assume that the controller node 12 has a packet P1 for communication to the mobile device 14. The controller node 12 communicates the packet P1 to the mobile device 14 at a time T1 via a downlink wireless communications channel 16 at a downlink transmit power. The downlink wireless communications channel 16 may have certain impairments or degradations associated with it, such as fading, noise, interference, and the like. A quality of the downlink wireless communications channel 16 may be quantified via any number of different channel metrics, such as for example, a signal-to-noise ratio (SNR), signal-to-interference-plus-noise ratio (SINR), and the like. If the quality of the downlink wireless communications channel 16 is such that the mobile device 14 is unable to recover the packet P1, the mobile device 14 may indicate this to the controller node 12, such as by sending a negative acknowledge message (NACK) to the controller node 12. The controller node 12 may then retransmit the packet P1, perhaps using a less aggressive modulation scheme. Retransmissions due to a poor quality wireless communications channel can significantly negatively impact the overall system throughput of the system 10.

Assume that the mobile device 14 transmits a packet P2 to the controller node 12 at a time T2 via an uplink wireless communications channel 18 at an uplink transmit power. The uplink wireless communications channel 18 also has a quality that may be quantified via one or more desired channel metrics. The quality of the uplink wireless communications channel 18 may differ from that of the downlink wireless communications channel 16 due to different interference environments, differences in transmit powers between the uplink transmit power and the downlink transmit power, and other factors.

As the mobile device 14 nears a cell edge and the distance between the controller node 12 and the mobile device 14 increases, the quality of the wireless communications channels 16, 18 may decrease, resulting in retransmissions, and a reduction in overall system throughput of the system 10. The use of a relay node may reduce the number of such retransmissions. FIG. 1B is a block diagram illustrating a relay transmission mode according to one embodiment, in which a relay node 20 facilitates communications between the controller node 12 and the mobile device 14. The relay node 20 may comprise any suitable intermediary device that is capable of relaying messages. In the context of a LTE or LTE-A wireless communications system, the relay node 20 may comprise a picocell node, or a femtocell node, such as a 3GPP home eNodeB (HeNB) base station. In this transmission mode, the controller node 12 communicates with the mobile device 14 via the relay node 20. Assume again that the controller node 12 has a packet P1 for communication to the mobile device 14. The controller node 12 communicates the packet P1 to the relay node 20 at a time T1 via a downlink wireless communications channel 22 at a respective downlink transmit power. The quality of the downlink wireless communications channel 22 may be higher than the quality of the downlink wireless communications channel 16 with the mobile device 14 because of the closer distance of the relay node 20 to the controller node 12, decreasing the likelihood of retransmissions. At a time T2, the relay node 20 communicates the packet P1 to the mobile device 14 via a downlink wireless communications channel 26 at a respective downlink transmit power.

The mobile device 14 transmits a packet P2 to the relay node 20 at a time T3 via an uplink wireless communications channel 28 at a respective uplink transmit power. At a time T4, the relay node 20 communicates the packet P2 to the controller node 12 via an uplink wireless communications channel 30 at a respective uplink transmit power.

Due to the closer proximity of the relay node 20 to the controller node 12 and the mobile device 14, the quality of the wireless communications channels 22, 26-30 may each have higher quality than the wireless communication channels 16, 18 directly between the controller node 12 and the mobile device 14. This may result in fewer retransmissions. Unfortunately, the use of the relay node 20 resulted in four transmissions at the times T1-T4, twice the number of transmissions required to communicate directly between the controller node 12 and the mobile device 14. Thus, the use of the relay node 20, while reducing retransmissions, increases the number of time slots used to transmit packets, and thus may reduce overall system throughput of the system 10.

In some embodiments, a device, such as the controller node 12, relay node 20, or mobile device 14 may “overhear” the transmission of a packet that is directed to a device other than itself, but that is ultimately destined for the other device. Overhearing may occur in the context of wireless communications due to the broadcast nature of wireless communications. Overhearing can be used to implement diversity, wherein a device receives multiple copies of a packet, and may then soft combine the copies to generate a combined packet. The combined packet has a greater likelihood of containing all the transmitted data than any of the individual copies. Thus, the use of overhearing may also reduce retransmissions, and help increase the system throughput of the system 10.

Overhearing can be facilitated, for example, by the use of scheduled transmissions, such that a device is aware of a future transmission of data from a transmitting device to a receiving device, and can choose to listen for the transmission. Overheard packets will be identified herein with the subscript “OH,” and combined packets will be identified herein with the subscript “CO.” For example, assume that the mobile device 14 overhears a packet P1_{OH} transmitted at the time T1 from the controller node 12 to the relay node 20. The mobile device 14 may retain the packet P1_{OH} and, after receiving the packet P1 from the relay node 20, soft combine the two packets P1_{OH}, P1 to generate a combined packet P1_{CO}. It is possible that neither of the two packets P1_{OH}, P1 were completely received by the mobile device 14, but after combining the two packets P1_{OH}, P1, all the data in the original packet P1 transmitted by the controller node 12 was recovered, thus eliminating a need to retransmit the original packet P1.

Similarly, the controller node 12 may overhear a packet P2_{OH} transmitted at the time T3 from the mobile device 14 to the relay node 20. The controller node 12 may retain the packet P2_{OH} and, after receiving the packet P2 from the relay node 20, soft combine the two packets P2_{OH}, P2 to generate a combined packet P2_{CO}.

FIG. 1C is a block diagram illustrating a network coding transmission mode according to one embodiment, in which a relay node 20 facilitates communications between the controller node 12 and the mobile device 14 and network codes packets to reduce the number of time slots otherwise used to transmit the packets P1 and P2. Assume again that the controller node 12 has a packet P1 for communication to the mobile device 14. The controller node 12 communicates the packet P1 to the relay node 20 at a time T1 via the downlink wireless communications channel 22 at a respective downlink transmit power. The controller node 12 may also retain a copy of the packet P1 for use in decoding a subsequently received network-coded packet, as described in greater detail herein. The mobile device 14 then transmits a packet P2 to the relay node 20 at a time T2 via the uplink wireless communications channel 28 at a respective uplink transmit power. The mobile device 14 also retains a copy of the packet P1 for use in decoding a subsequently received network-coded packet. The relay node 20 network codes the packets P1, P2 to form a network-coded packet P1⊖P2.

Network coding typically involves the use of a logical operation or function, such as an exclusive OR (XOR) function, that operates on the bits of data in the packet P1 and the packet P2 to form the combined packet referred to herein as the network-coded packet P1⊖P2. The network-coded packet P1⊖P2 comprises a fewer number of bits than the total number of bits in both the packets P1, P2, and yet, when the network-coded packet P1⊖P2 is properly decoded, both packets P1, P2 can be extracted or otherwise derived from the network-coded packet P1⊖P2. The symbol “⊖” is used in the drawings to depict network-coded packets. While for purposes of illustration only two packets are discussed as being network-coded, network coding is not limited to only two packets, and a greater number of packets may be network-coded to thereby form a network-coded packet from which each of such greater number of packets may be extracted when properly decoded.

The relay node 20 then broadcasts the network-coded packet P1⊖P2 to both the controller node 12 and the mobile device 14 at a time T3. The controller node 12 may use the retained packed P1 to decode the network-coded packet P1⊖P2 and extract the packet P2 that originated with the mobile device 14. Similarly, the mobile device 14 may use the retained packed P2 to decode the network-coded packet P1⊖P2 and extract the packet P1 that originated with the controller node 12. The network coding transmission mode in this example reduced by 25% the number of time slots necessary to facilitate the exchange of the packets P1, P2 between the controller node 12 and the mobile device 14 compared to the relay transmission mode discussed with regard to FIG. 1B.

Moreover, as discussed with regard to FIG. 1B, overhearing can be used in the network coding transmission mode for diversity purposes. In this example, the mobile device 14 may overhear the packet P1_{OH} transmitted at the time T1 from the controller node 12 to the relay node 20. After extracting the packet P1 from the network-coded packet P1⊖P2, the mobile device 14 may soft combine the two packets P1_{OH}, P1 to generate a combined packet P1_{CO}.

Similarly, the controller node 12 may overhear a packet P2_{OH} transmitted at the time T2 from the mobile device 14 to the relay node 20. After extracting the packet P2 from the network-coded packet P1⊖P2, the controller node 12 may soft combine the two packets P2_{OH}, P2 to generate a combined packet P2_{CO}.

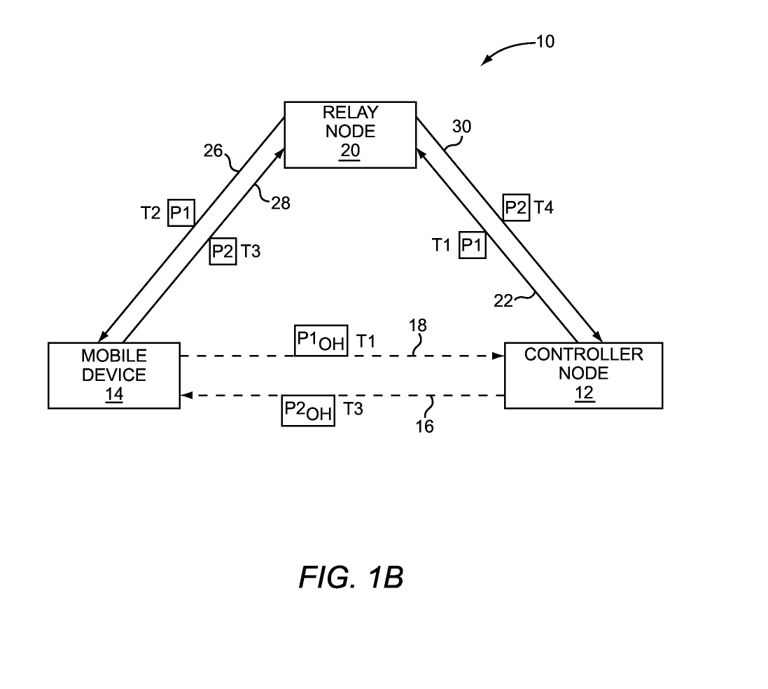

FIG. 2 is a flowchart illustrating a method for selecting a transmission mode with the mobile device 14 according to one embodiment. FIG. 2 will be discussed in conjunction with FIGS. 1A-1C. The controller node 12 determines a plurality of rate regions, each rate region corresponding to a particular transmission mode of a plurality of transmission modes (FIG. 2, block 1000). For purposes of illustration assume that the plurality of transmission modes comprises the direct transmission mode discussed above with regard to FIG. 1A, the relay transmission mode discussed above with regard to FIG. 1B, and the network coding transmission mode discussed above with regard to FIG. 1C; however, the embodiments are not limited to these three transmission modes and have applicability in any wireless communications system that may implement multiple transmission modes.

The phrase “rate region,” as used herein, refers to any metric that can quantify or estimate a throughput between the controller node 12 and the mobile device 14 if such devices used a particular transmission mode. In some embodiments, the rate region is based, at least in part, on channel metrics that quantify the wireless communications channels between devices that would be used to implement the particular transmission mode. Such channel metrics may include, for example, a channel quality index (CQI), SNR, SINR, or the like. Some or all of this data may be determined by one or more devices and provided to the controller node 12 for use in determining the respective rate region. For example, the relay node 20 may provide to the controller node 12 a channel metric that identifies the quality of the downlink wireless communications channel 22 and a channel metric that identifies the quality of the uplink wireless communications channel 28. The mobile device 14 may provide to the controller node 12, either directly or via the relay node 20, a channel metric that identifies the quality of the downlink wireless communications channel 26 and a channel metric that identifies the quality of the downlink wireless communications channel 16. The controller node 12 may determine a channel metric that identifies the quality of the uplink wireless communications channel 30 and a channel metric that identifies the quality of the uplink wireless communications channel 18.

In some embodiments, the controller node 12 may, at least in part, determine the rate regions based on a Shannon capacity of the wireless communications channels in accordance with a formula substantially in accordance with:

C_{xy}=Blog₂(1+γ_{xy}), (1)

wherein C_{xy} is the Shannon capacity of the wireless communication channel between nodes x and y and γ_{xy} is the SNR between the nodes x and y.

In one embodiment, the controller node 12 may determine a rate region for the direct transmission mode substantially in accordance with the following rate region formula:

R_{M-C}≦T₁C_{M-C}

R_{C-M}≦T₂C_{C-M}

T₁+T₂≦1 (2)

wherein the subscript “M” refers to the mobile device 14, the subscript “C” refers to the controller node 12, R_{M-C} the uplink rate between the mobile device 14 and the controller node 12, R_{C-M} is the downlink rate between the controller node 12 and the mobile device 14, C_{M-C} is the Shannon capacity of the uplink wireless communications channel 18, C_{C-M} is the Shannon capacity of the downlink wireless communications channel 16, and T₁ and T₂ are time-sharing parameters for exchanging the data between the controller node 12 and the mobile device 14.

Using formula (2) the controller node can derive, using linear programming for example, the rates R_{M-C} and R_{C-M} and thereby determine the rate region for the direct transmission mode. In one embodiment, the rates R_{M-C} and R_{C-M} are solved such that the rate region is maximized. The rate region may comprise, for example, the area of the graph defined by R_{M-C} and R_{C-M}.

In one embodiment, the controller node 12 may determine a rate region for the relay transmission mode substantially in accordance with the following rate region formula:

R_{M-C}≦T₁C_{M-R}

R_{M-C}≦T₁C_{M-C}+T₂C_{R-C}

R_{C-M}≦T₃C_{C-R}

R_{C-M}≦T₃C_{C-M}+T₄C_{R-M}

T₁+T₂+T₃+T₄≦ (3)

wherein the subscript “M” refers to the mobile device 14, the subscript “C” refers to the controller node 12, the subscript “R” refers to the relay node 20, R_{M-C} is the uplink rate between the mobile device 14 and the controller node 12, R_{C-M} is the downlink rate between the controller node 12 and the mobile device 14, C_{M-R} is the Shannon capacity of the uplink wireless communications channel 28, C_{M-C} is the Shannon capacity of the uplink wireless communications channel 18, C_{R-C} is the Shannon capacity of the uplink wireless communications channel 30, C_{C-R} is the Shannon capacity of the downlink wireless communications channel 22, C_{C-M}is the Shannon capacity of the downlink wireless communications channel 16, C_{R-M} is the Shannon capacity of the downlink wireless communications channel 26, and T₁, T₂, T₃, and T₄ are the transmission times it will take to exchange the data between the controller node 12 and the mobile device 14 via the relay node 20.

Using formula (3) the controller node can derive, using linear programming for example, the rates R_{M-C} and R_{C-M} and thereby determine the rate region for the relay transmission mode.

In one embodiment, the controller node 12 may determine a rate region for the network coding transmission mode substantially in accordance with the following rate region formula:

R_{M-C}≦T₁C_{M-R}

R_{M-C}≦T₁C_{M-C}+T₃Cₘᵢₙ

R_{C-M}≦T₂C_{C-R}

R_{C-M}≦T₂C_{C-M}+T₃Cₘᵢₙ

T₁+T₂+T₃≦1 (4)

wherein the subscript “M” refers to the mobile device 14, the subscript “C” refers to the controller node 12, the subscript “R” refers to the relay node 20, wherein R_{M-C} is the uplink rate between the mobile device 14 and the controller node 12, C_{M-R} is the Shannon capacity of the uplink wireless communications channel 28, C_{M-C} is the Shannon capacity of the uplink wireless communications channel 18, Cₘᵢₙ is the minimum of the Shannon capacity of the downlink wireless communications channel 26 (C_{R-M}) and the Shannon capacity of the uplink wireless communications channel 30 (C_{R-C}), R_{C-M} is the downlink rate between the controller node 12 and the mobile device 14, C_{C-R} is the Shannon capacity of the downlink wireless communications channel 22, C_{C-M} is the Shannon capacity of the downlink wireless communications channel 16, and T₁, T₂, T₃ and T₄ are the transmission times it will take to exchange the data between the controller node 12 and the mobile device 14 via the relay node 20.

Using formula (4) the controller node can derive, using linear programming for example, the rates R_{M-C} and R_{C-M} and thereby determine the rate region for the network coding transmission mode.

After determination of the rate regions that correspond to the direct transmission mode, relay transmission mode, and network coding transmission mode, respectively, the controller node 12 may identify a selected one of the rate regions (FIG. 2, block 1002). The identification may be based on the best rate region of the three rate regions. In one embodiment, the identification is based on which transmission mode provides the maximum rate region.

The controller node 12 may then engage in wireless communications with the mobile device 14 using a selected transmission mode that corresponds to the selected rate region (FIG. 2, block 1004).

In some embodiments, the controller node 12 may send a control signal to the mobile device 14 and/or relay node 20 that identifies the selected transmission mode. In the context of a LTE or LTE-A wireless communications system, the controller node 12 may send the control signal that identifies the selected transmission mode to the relay node 20 in a relay physical downlink control channel (R-PDCCH), or in a relay physical downlink shared channel (R-PDSCH), and to the mobile device 14 as part of the physical downlink shared channel (PDSCH) or physical downlink control channel (PDCCH).

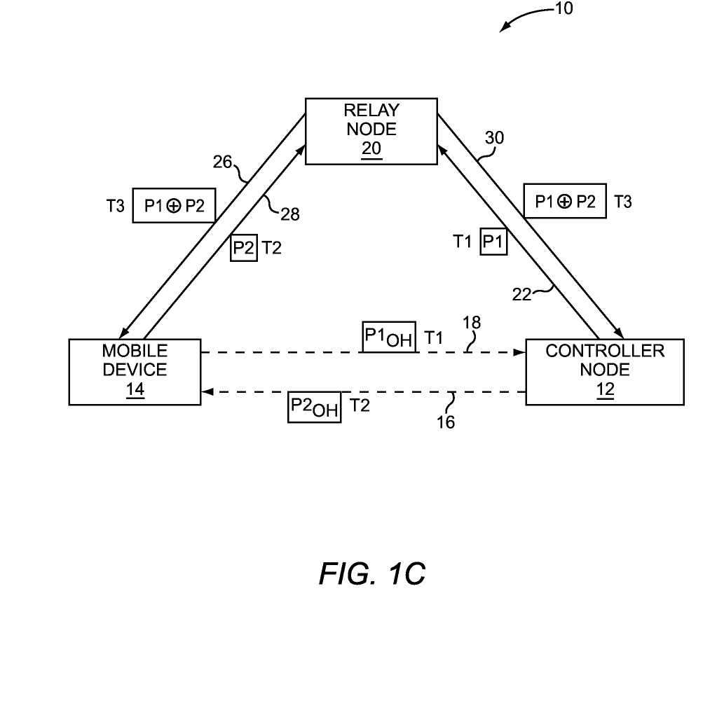

FIG. 3 is a block diagram illustrating a radio frame 32 showing example wireless communications between the controller node 12 and the mobile device 14 in accordance with the direct transmission mode according to one embodiment. While for the purposes of illustration the radio frame 32 is shown in accordance with a LTE-A protocol, the embodiments are not limited to any particular protocol. Assume that the controller node 12 has sent the mobile device 14 a control signal identifying the transmission mode as the direct transmission mode. At subframe 0 (SF0), the controller node 12 sends a packet P1 to the mobile device 14. The mobile device 14 receives the packet P1. If the mobile device 14 is able to successfully receive the packet P1, the mobile device 14 may send an acknowledge message (ACK) (not illustrated) to the controller node 12. At subframe 2 (SF2) the mobile device 14 sends a packet P2 to the controller node 12. The controller node 12 receives the packet P2.

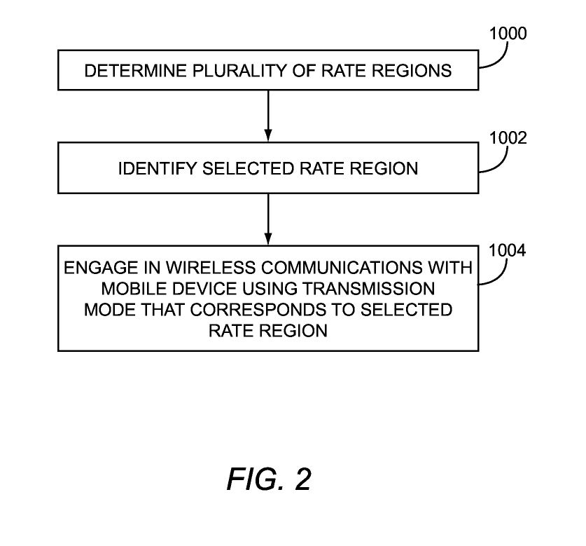

FIG. 4 is a block diagram illustrating a radio frame 34 showing example wireless communications between the controller node 12 and the mobile device 14 via the relay node 20 in accordance with the relay node transmission mode according to one embodiment. While for the purposes of illustration the radio frame 34 is shown in accordance with a LTE-A protocol, the embodiments are not limited to any particular protocol. Assume that the controller node 12 has sent the mobile device 14 and the relay node 20 a control signal identifying the transmission mode as the direct transmission mode. As discussed above, in one embodiment the controller node 12 may send this control signal to the relay node 20 as part of the R-PDCCH or R-PDSCH, and to the mobile device 14 as part of the PDSCH or PDCCH.

At SF0, the controller node 12 sends a packet P1 to the relay node 20. The relay node 20 receives the packet P1. Assume in this example that devices may overhear transmissions for the purpose of implementing diversity, or to eliminate or reduce additional transmissions from a device, as discussed in greater detail herein. The mobile device 14 overhears the transmission (P1_{OH}) from the controller node 12. If either of the mobile device 14 and/or the relay node 20 successfully receive the packet P1_{OH} or P1, respectively, one or both devices may send an ACK (not illustrated) to the controller node 12. If an ACK is received from either the mobile device 14 or the relay node 20, the controller node 12 may drop the packet P1.

If the mobile device 14 successfully receives the packet P1_{OH}, the mobile device 14 may send an ACK and then process the packet P1_{OH}. If the mobile device 14 is not able to successfully receive the packet P1_{OH}, the mobile device 14 may wait for the relay of the packet P1 from the relay node 20 at subframe 4 (SF4). In the meantime, the mobile device 14 sends a packet P2 to the relay node 20. The relay node 20 receives the packet P2. The controller node 12 overhears the transmission (P2_{OH}) from the mobile device 14.

At SF4, the relay node 20 transmits the packet P1 to the mobile device 14. If the mobile device 14 has already successfully received the packet P1_{OH}, the mobile device 14 may simply disregard the transmission. If the mobile device 14 was not able to receive the packet P1_{OH}, the mobile device 14 will attempt to successfully receive the relay of the packet P1 from the relay node 20. The mobile device 14 may soft combine the contents of the packet P1_{OH} and the packet P1. If the mobile device 14 is still unable to recover the contents of the packet P1_{OH} or the packet P1, the mobile device 14 may send a negative acknowledge message (NACK) (not illustrated) to the relay node 20, so that the relay node 20 may attempt to send the packet P1 again.

At subframe 8 (SF8), the relay node 20 transmits the packet P2 to the controller node 12. If the controller node 12 has already successfully received the packet P2_{OH}, the controller node 12 may simply disregard the transmission.

If the controller node 12 was not able to receive the packet P2_{OH}, the controller node 12 will attempt to successfully receive the relay of the packet P2 from the relay node 20. If the controller node 12 is unable to receive the packet P2_{OH} or the packet P2, the controller node 12 may send a NACK (not illustrated) to the relay node 20, so that the relay node 20 may attempt to send the packet P2 again.

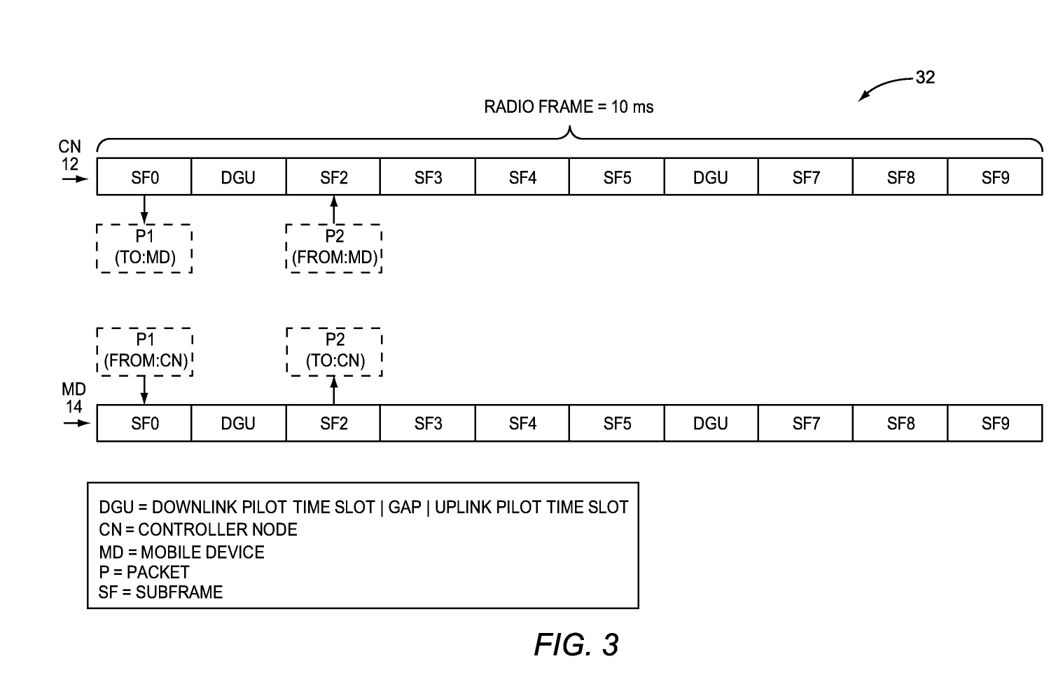

FIG. 5 is a block diagram illustrating a radio frame 36 showing example wireless communications between the controller node 12 and the mobile device 14 via the relay node 20 in accordance with the network coding transmission mode according to one embodiment. While for the purposes of illustration the radio frame 36 is shown in accordance with a LTE-A protocol, the embodiments are not limited to any particular protocol. Assume that the controller node 12 has sent the mobile device 14 and the relay node 20 a control signal identifying the transmission mode as the network coding transmission mode. As discussed above, in one embodiment the controller node 12 may send this control signal as part of the R-PDCCH or R-PDSCH, and/or as part of the PDSCH or PDCCH.

At SF0, the controller node 12 sends a packet P1 to the relay node 20. The relay node 20 receives the packet P1. Assume in this example devices may overhear transmissions for the purpose of implementing diversity, or to eliminate or reduce additional transmissions from a device, as discussed in greater detail herein. The mobile device 14 overhears the transmission (P1_{OH}) from the controller node 12. If either of the mobile device 14 and/or the relay node 20 successfully receive the packet P1_{OH} or P1, respectively, one or both devices may send an ACK (not illustrated) to the controller node 12. Because the transmission mode is the network coding transmission mode, the controller node 12 may retain the packet P1 for use in decoding a network-coded packet P1⊖P2 which may subsequently be sent by the relay node 20, as discussed in greater detail below.

If the mobile device 14 successfully receives the packet P1_{OH}, the mobile device 14 may send an ACK and then process the packet P1_{OH}. If the mobile device 14 is not able to successfully receive the packet P1_{OH}, the mobile device 14 may wait for the relay of the network-coded packet P1⊖P2 from the relay node 20 at SF4. In the meantime, the mobile device 14 sends a packet P2 to the relay node 20. The relay node 20 receives the packet P2. The controller node 12 overhears the transmission (P2_{OH}) from the mobile device 14. If the controller node 12 successfully receives the packet P2_{OH}, the controller node 12 may send an ACK and then process the packet P2_{OH}, and can also drop the packet P1 since it is no longer needed to decode the network-coded packet P1⊖P2. If the controller node 12 is not able to successfully receive the packet P2_{OH}, the controller node 12 may wait for the relay of the network-coded packet P1⊖P2 from the relay node 20 at SF4.

The relay node 20 may overhear the transmission of ACKs or NACKs from the controller node 12 and the mobile device 14. If the relay node 20 receives ACKs from both the controller node 12 and the mobile device 14, the relay node 20 knows that there is no need to send the network-coded packet P1⊖P2 at SF4. Otherwise, the relay node 20 network codes the packets P1 and P2 to form the network-coded packet P1⊖P2 and broadcasts, or otherwise sends, the network-coded packet P1⊖P2 to the controller node 12 and the mobile device 14.

In some embodiments, the relay node 20 may use a downlink transmit power level to transmit packets to the mobile device 14 and an uplink transmit power level to transmit packets to the controller node 12. The downlink transmit power level and the uplink transmit power level may differ from one another. Because the broadcast of the network-coded packet P1⊖P2 is destined for both the controller node 12 and the mobile device 14, the relay node 20 in one embodiment may use the larger transmit power level of the downlink transmit power level and the uplink transmit power level to broadcast the network-coded packet P1⊖P2. Notably, using the larger transmit power level may affect the rate region determinations discussed above.

In some wireless telecommunications systems, such as LTE and LTE-A wireless telecommunications systems, different multiplexing techniques may be used on the uplink and the downlink. For example, in LTE and LTE-A, orthogonal frequency-division multiple access (OFDMA) is used on the downlink, and single carrier frequency-division multiple access (SC-FDMA) is used on the uplink. In such wireless telecommunications systems, in order for network coding to operate, the wireless telecommunications system would accept, for the transmission of network-coded packets, a deviation from this such that the transmission of the network-coded packet P1⊖P2 uses either OFDMA or SC-FDMA. The controller node 12 and mobile device 14 would interpret the network-coded packet P1⊖P2 appropriately based on the use of the network coding transmission mode. Since the relay node 20 may have a larger power capacity than the mobile device 14, in some embodiments OFDMA may be preferable to the use of SC-FDMA for transmission of the network-coded packet P1⊖P2.

The controller node 12 receives the network-coded packet P1⊖P2, and if necessary, decodes the network-coded packet P1⊖P2 using the retained packet P1. Similarly, the mobile device 14 receives the network-coded packet P1⊖P2, and if necessary, decodes the network-coded packet P1⊖P2 using the retained packet P2.

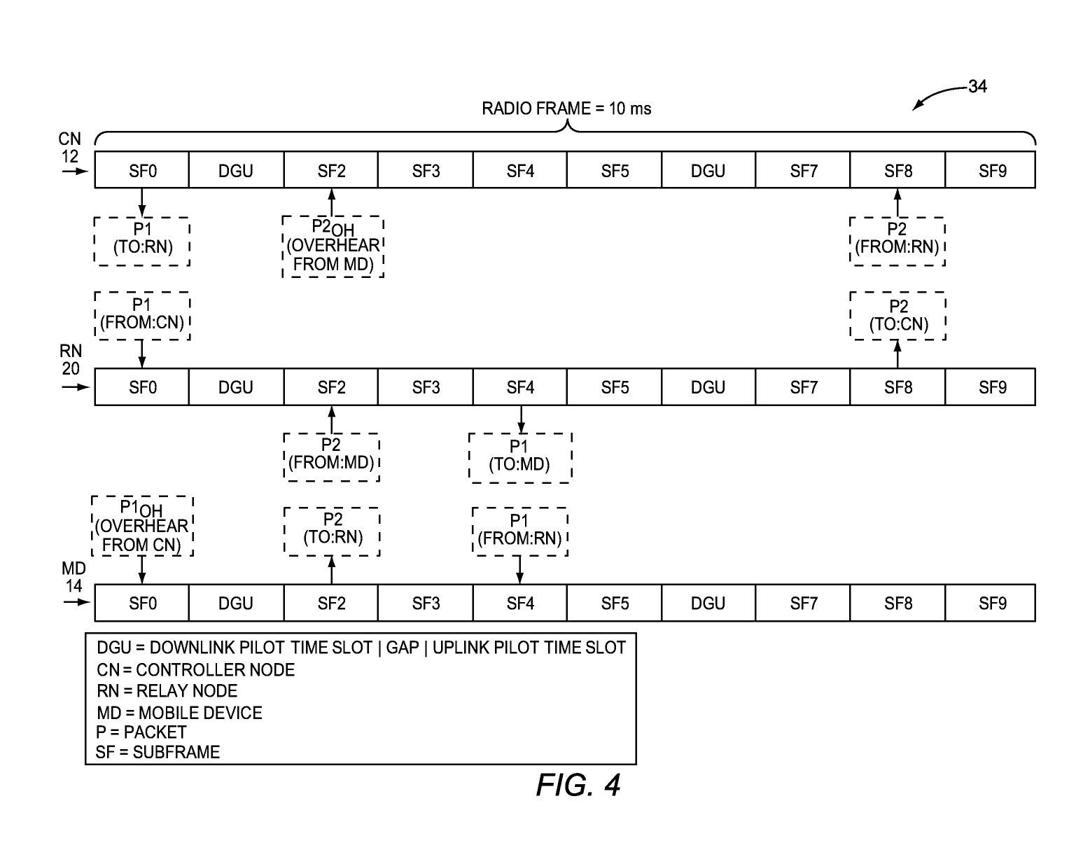

FIG. 6 is a block diagram of a controller node 12 suitable for implementing aspects of the embodiments disclosed herein. As discussed above, in the context of a LTE or LTE-A system, the controller node 12 may comprise an eNodeB. In the context of a Wi-Fi® system, the controller node 12 may comprise, for example, a WAP. The controller node 12 includes a communications interface 40 and a controller 42. The communications interface 40 generally includes analog and/or digital components for sending and receiving communications to and from other devices, such as the mobile device 14 and relay node 20, and may also include capabilities for wired communication for out-of-band backhaul and communications with one or more networks. Those skilled in the art will appreciate that the block diagram of the controller node 12 necessarily omits numerous features that are not necessary for a complete understanding of this disclosure.

Although all of the details of the controller 42 are not illustrated, the controller 42 comprises one or several general-purpose or special-purpose processors 44 or other microcontrollers programmed with suitable software programming instructions and/or firmware to carry out some or all of the functionality of the controller nodes 12 described herein. In addition, or alternatively, the controller 42 may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the controller node 12 described herein. A memory 46, such as a random access memory (RAM), may be used by the processor 44 to store data and programming instructions which, when executed by the processor 44, implement all or part of the functionality described herein. The controller node 12 may also include one or more storage media (not illustrated) for storing data necessary and/or suitable for implementing the functionality described herein, as well as for storing the programming instructions which, when executed on the processor 44, implement all or part of the functionality described herein. One embodiment of the present disclosure may be implemented as a computer program product that is stored on a computer-readable storage medium, the computer program product including programming instructions that are configured to cause the processor 44 to carry out the steps described herein.

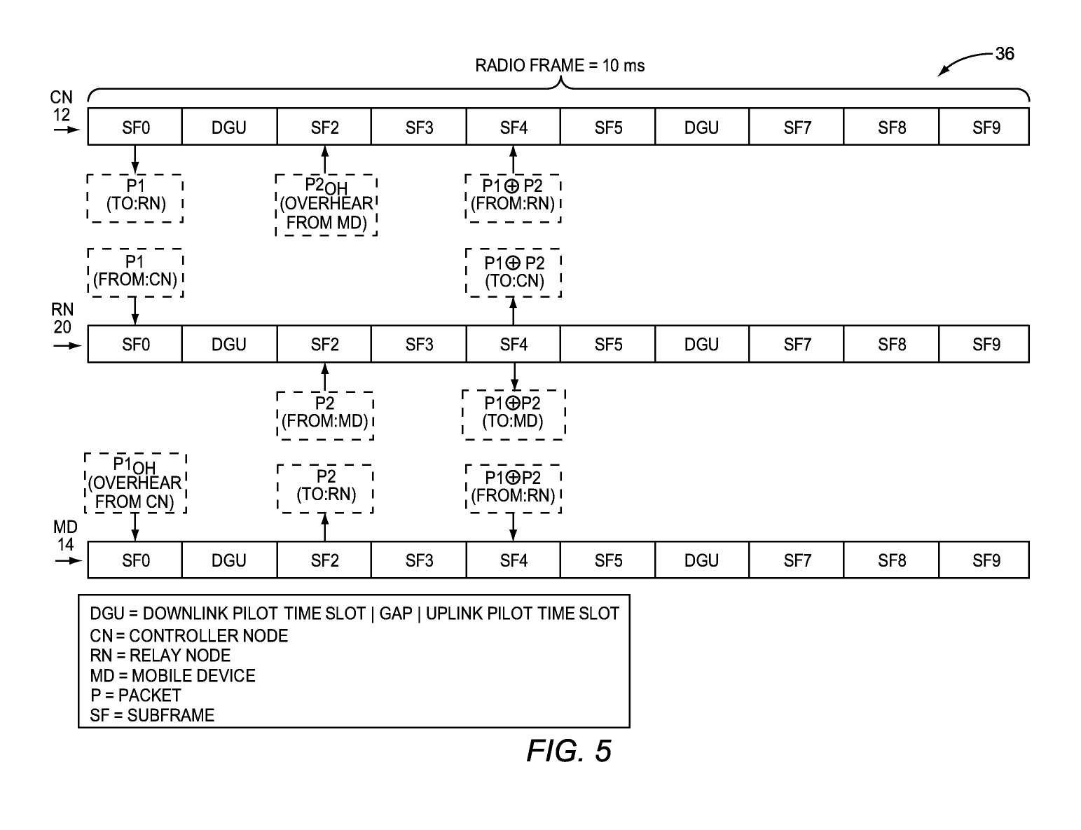

FIG. 7 is a block diagram of a relay node 20 suitable for implementing aspects of the embodiments disclosed herein. In some embodiments, as discussed above, in the context of a LTE or LTE-A system, the relay node 20 may comprise a picocell node, or a femtocell node, such as a 3GPP HeNB base station.

The relay node 20 includes a communications interface 48 and a controller 50. The communications interface 48 generally includes analog and/or digital components for sending and receiving communications to and from other devices, such as the mobile device 14 and the controller node 12, and may also include capabilities for wired communication for out-of-band backhaul and communications with one or more networks. Those skilled in the art will appreciate that the block diagram of the relay node 20 necessarily omits numerous features that are not necessary for a complete understanding of this disclosure.

Although all of the details of the controller 50 are not illustrated, the controller 50 comprises one or several general-purpose or special-purpose processors 52 or other microcontrollers programmed with suitable software programming instructions and/or firmware to carry out some or all of the functionality of the relay node 20 described herein. In addition, or alternatively, the controller 50 may comprise various digital hardware blocks (e.g., one or more ASICs, one or more off-the-shelf digital or analog hardware components, or a combination thereof) (not illustrated) configured to carry out some or all of the functionality of the relay node 20 described herein. A memory 54, such as RAM, may be used by the processor 52 to store data and programming instructions which, when executed by the processor 52, implement all or part of the functionality described herein. The relay node 20 may also include one or more storage media (not illustrated) for storing data necessary and/or suitable for implementing the functionality described herein, as well as for storing the programming instructions which, when executed on the processor 52, implement all or part of the functionality described herein. One embodiment of the present disclosure may be implemented as a computer program product that is stored on a computer-readable storage medium, the computer program product including programming instructions that are configured to cause the processor 52 to carry out the steps described herein.

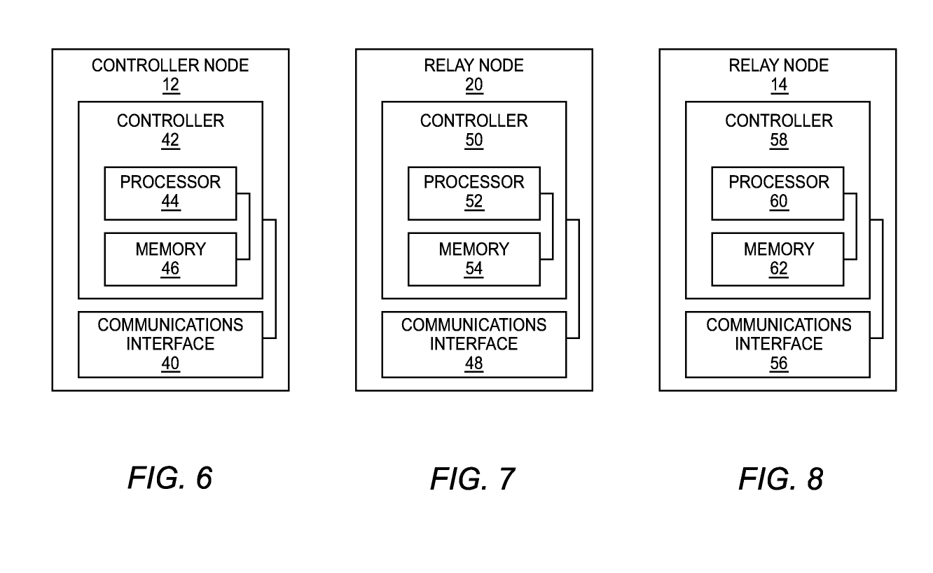

FIG. 8 is a block diagram of a mobile device 14 according to one embodiment. As discussed above, the mobile device 14 may comprise any device capable of wireless communications, including, for example, a smart phone; a portable computer such as a laptop or notebook computer; a computer tablet; a personal digital assistant (PDA), or the like. The mobile device 14 includes a communications interface 56 and a controller 58. The communications interface 56 generally includes analog and/or digital components for sending and receiving communications to and from other wireless devices, including, for example, the controller node 12 and the relay node 20. Those skilled in the art will appreciate that the block diagram of the mobile device 14 necessarily omits numerous features that are not necessary for a complete understanding of this disclosure.

Although all of the details of the controller 58 are not illustrated, the controller 58 comprises one or several general-purpose or special-purpose processors 60 or other microcontrollers programmed with suitable software programming instructions and/or firmware to carry out some or all of the functionality of the mobile device 14 described herein. In addition, or alternatively, the controller 58 may comprise various digital hardware blocks (e.g., one or more ASICs, one or more off-the-shelf digital or analog hardware components, or a combination thereof) (not illustrated) configured to carry out some or all of the functionality of the mobile device 14 described herein. A memory 62, such as RAM, may be used by the processor 60 to store data and programming instructions which, when executed by the processor 60, implement all or part of the functionality described herein. The mobile device 14 may also include one or more storage media (not illustrated) for storing data necessary and/or suitable for implementing the functionality described herein, as well as for storing the programming instructions which, when executed on the processor 60, implement all or part of the functionality described herein. One embodiment of the present disclosure may be implemented as a computer program product that is stored on a computer-readable storage medium, the computer program product including programming instructions that are configured to cause the processor 60 to carry out the steps described herein.

While the embodiments have been discussed in the context of LTE and LTE-A, the embodiments may be applicable to other wireless communications systems, including, by way of non-limiting example, UMTS, HSPA, CDMA, and WiMax. The embodiments may, among other advantages, increase system throughput, reduce the number of packet transmissions and retransmissions, save battery life of the mobile device 14 due to fewer packet transmissions, and handle more users using the same resources.

The following acronyms are used throughout this disclosure:
3GPP 3rd Generation Partnership Project
ACK Acknowledge Message
ASIC Application Specific Integrated Circuit
CQI Channel Quality Index
eNodeB Evolved Universal Terrestrial Radio Access Network Node B
HeNB Home eNodeB
HetNet Heterogeneous Network
LAN Local Area Network
LTE Long Term Evolution
LTE-A Long Term Evolution Advanced
NACK Negative Acknowledge Message
OFDMA Orthogonal Frequency-Division Multiple Access
OH Overheard
P Packet
PDA Personal Digital Assistant
PDCCH Physical Downlink Control Channel
PDSCH Physical Downlink Shared Channel
RAM Random Access Memory
R-PDCCH Relay Physical Downlink Control Channel
R-PDSCH Relay Physical Downlink Shared Channel
SC-FDMA Single Carrier Frequency-Division Multiple Access
SF Subframe
SINR Signal-To-Interference-Plus-Noise Ratio
SNR Signal-To-Noise Ratio
T Time
UE User Equipment
WAP Wireless Access Point
XOR Exclusive OR

Those skilled in the art will recognize improvements and modifications to the preferred embodiments of the present disclosure. All such improvements and modifications are considered within the scope of the concepts disclosed herein and the claims that follow.

What is claimed is:

1. A method for selecting a transmission mode for wireless communications with a mobile device, comprising:
determining, by a controller node, a plurality of rate regions, each rate region corresponding to a transmission mode of a plurality of transmission modes;
identifying a selected rate region of the plurality of rate regions; and
engaging in wireless communications with the mobile device using a selected transmission mode that corresponds to the selected rate region.

2. The method of claim 1, further comprising sending a control signal to the mobile device that identifies the selected transmission mode.

3. The method of claim 1, further comprising sending a control signal to a relay node that identifies the selected transmission mode.

4. The method of claim 1, wherein determining the plurality of rate regions comprises:
determining a first rate region based on a first rate region formula associated with a direct transmission mode of the plurality of transmission modes;
determining a second rate region based on a second rate region formula associated with a relay transmission mode of the plurality of transmission modes; and
determining a third rate region based on a third rate region formula associated with a network coding transmission mode of the plurality of transmission modes.

5. The method of claim 4, wherein the second rate region formula is based at least in part on a signal-to-noise ratio (SNR) of a wireless channel between the controller node and a relay node, a SNR of a wireless channel between the relay node and the mobile device, and a SNR of a wireless channel between the controller node and the mobile device.

6. The method of claim 4, wherein the second rate region formula is based at least in part on an uplink signal-to-noise ratio (SNR) of an uplink wireless channel between the controller node and a relay node, a downlink SNR of a downlink wireless channel between the controller node and the relay node, an uplink SNR of an uplink wireless channel between the relay node and the mobile device, a downlink SNR of a downlink wireless channel between the relay node and the mobile device, an uplink SNR of an uplink wireless channel between the controller node and the mobile device, and a downlink SNR of a downlink wireless channel between the controller node and the mobile device.

7. A method for selecting a transmission mode for wireless communications with a user equipment (UE) in a Long Term Evolution Advanced (LTE-A) wireless communications system comprising:
determining, by a Universal Terrestrial Radio Access Network Node B (eNodeB), a plurality of rate regions, each rate region corresponding to a transmission mode of a plurality of transmission modes;
identifying a selected rate region of the plurality of rate regions; and
engaging in wireless communications with the UE device using a selected transmission mode that corresponds to the selected rate region.

8. The method of claim 7, further comprising:
sending, by the eNodeB to a relay node, a control signal in one of a relay physical downlink control channel (R-PDCCH) and a relay physical downlink shared channel (R-PDSCH), wherein the control signal identifies the selected transmission mode.

9. A method for implementing in a wireless telecommunications system a selected transmission mode of a plurality of transmission modes between a controller node and a mobile device, comprising:
receiving, by a relay node from the controller node, a control signal identifying the selected transmission mode;
relaying information from the controller node to the mobile device in accordance with the selected transmission mode; and
relaying information from the mobile device to the controller node in accordance with the selected transmission mode.

10. The method of claim 9, further comprising:
receiving a first packet of data from the controller node destined for the mobile device;
receiving a second packet of data from the mobile device destined for the controller node;
network coding the first packet and the second packet to generate a network-coded packet; and
broadcasting the network-coded packet to the controller node and the mobile device using orthogonal frequency division multiple access (OFDMA).

11. The method of claim 10, wherein the wireless communications system comprises a Long Term Evolution Advanced (LTE-A) wireless communications system.

12. The method of claim 10, wherein the relay node comprises an uplink transmit power level associated with wireless transmissions to the controller node and a downlink transmit power level associated with wireless transmissions to the mobile device, and wherein the network-coded packet is broadcasted to the controller node and the mobile device using a higher transmit power level of the uplink transmit power level and the downlink transmit power level.

13. A controller node for selecting a transmission mode for wireless communications with a mobile device comprising:
a communications interface configured to communicate wirelessly; and
a controller coupled to the communications interface, and configured to:
determine a plurality of rate regions, each rate region corresponding to a transmission mode of a plurality of transmission modes;
identify a selected rate region of the plurality of rate regions; and
engage in wireless communications with the mobile device using a selected transmission mode that corresponds to the selected rate region.

14. The controller node of claim 13, wherein to determine the plurality of rate regions the controller is further configured to:
determine a first rate region based on a first rate region formula associated with a direct transmission mode of the plurality of transmission modes;
determine a second rate region based on a second rate region formula associated with a relay transmission mode of the plurality of transmission modes; and
determine a third rate region based on a third rate region formula associated with a network coding transmission mode of the plurality of transmission modes.

15. The controller node of claim 14, wherein the second rate region formula is based at least in part on an uplink signal-to-noise ratio (SNR) of an uplink wireless channel between the controller node and a relay node, a downlink SNR of a downlink wireless channel between the controller node and the relay node, an uplink SNR of an uplink wireless channel between the relay node and the mobile device, a downlink SNR of a downlink wireless channel between the relay node and the mobile device, an uplink SNR of an uplink wireless channel between the controller node and the mobile device, and a downlink SNR of a downlink wireless channel between the controller node and the mobile device.

16. The controller node of claim 13, wherein the controller is further configured to:
send, to a relay node, a control signal in one of a relay physical downlink control channel (R-PDCCH) and a relay physical downlink shared channel (R-PDSCH), wherein the control signal identifies the selected transmission mode.

17. A relay node for implementing in a wireless telecommunications system a selected transmission mode between a controller node and a mobile device comprising:
a communications interface configured to communicate wirelessly; and
a controller coupled to the communications interface, and configured to:
receive, from the controller node, a control signal identifying the selected transmission mode; and
relay information from the controller node to the mobile device in accordance with the selected transmission mode.

18. The relay node of claim 17, wherein the controller is further configured to:
receive a first packet of data from the controller node destined for the mobile device;
receive a second packet of data from the mobile device destined for the controller node;
network code the first packet and the second packet to generate a network-coded packet; and
broadcast the network-coded packet to the controller node and the mobile device using orthogonal frequency-division multiple access (OFDMA).

19. The relay node of claim 18, wherein the relay node comprises an uplink transmit power level associated with wireless transmissions to the controller node and a downlink transmit power level associated with wireless transmissions to the mobile device, and wherein the network-coded packet is broadcasted to the controller node and the mobile device using a higher transmit power level of the uplink transmit power level and the downlink transmit power level.
